(19) United States
(12) Patent Application Publication
(10) Pub. No.: US 2018/0311705 A1
(43) Pub. Date: Nov. 1, 2018

(54) INSTALLATION FOR THE TREATMENT OF ARTICLES

(71) Applicant: EISENMANN SE, Boeblingen (DE)

(72) Inventor: Roland Barwich, Wildberg (DE)

(21) Appl. No.: 15/768,154

(22) PCT Filed: Sep. 21, 2016
(86) PCT No.: PCT/EP2016/072397

§ 371 Date: Apr. 13, 2018

(30) Foreign Application Priority Data
Oct. 16, 2015 (DE) 10 2015 013 457.4

(51) Int. Cl. B08B 3/02; B08B 13/00

(52) U.S. Cl. CPC B08B 3/022; B08B 13/00

(57) ABSTRACT

An installation for the rinsing of articles with liquid treatment medium, having a treatment chamber through which the articles can be conveyed by means of a conveying system in a conveyor direction, the treatment chamber having three treatment zones in which the articles can be impinged on with treatment medium. The third treatment zone the conveyor direction has a treatment device to which fresh treatment medium can be supplied. The first and second treatment zones in the conveyor direction each comprise one receiving basin for liquid treatment medium which drips from the articles. In the first and second treatment zones, the articles can be impinged on with treatment medium from the respective receiving basin. Means are provided through which treatment medium can be conducted from the third treatment zone into the receiving basin of the second treatment zone. By means of the first treatment zone, a monitoring zone is provided for the monitoring of the treatment medium in the control basin.

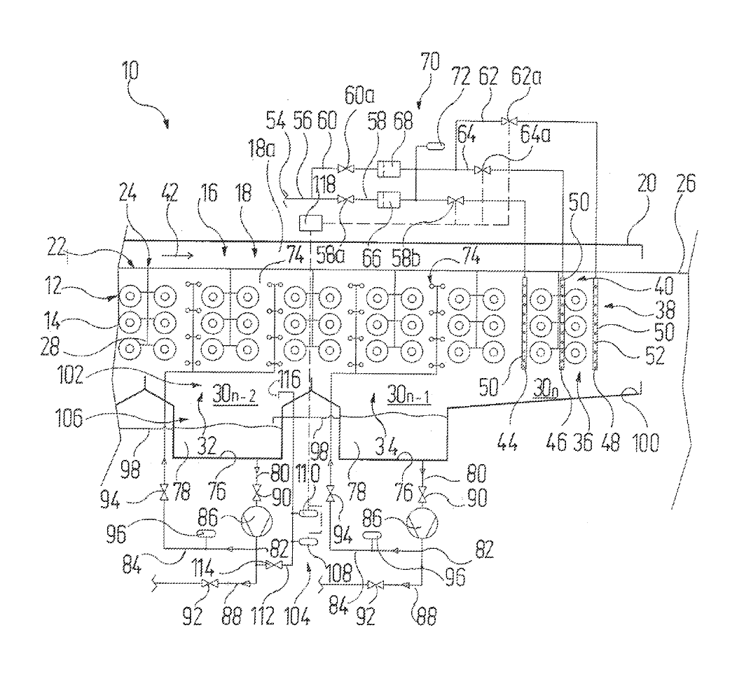

The invention relates to an installation for the treatment, in particular rinsing, of articles, in particular vehicle wheels, with a liquid treatment medium, comprising
a) a treatment chamber, through which the articles can be conveyed in a conveying direction by means of a conveying system and which, in the conveying direction, has at least three treatment zones, in which treatment medium can be applied to the articles;
   wherein
b) the third treatment zone in the conveying direction comprises a treatment device, to which fresh liquid treatment medium can be supplied;
c) the second treatment zone in the conveying direction and the first treatment zone in the conveying direction each comprise a receiving tank for liquid treatment medium which drips off or flows off the articles;
d) in the second treatment zone and in the first treatment zone, treatment medium from the respective receiving tank can be applied to the articles;
e) there are means by which treatment medium can be passed from the third treatment zone into the receiving tank of the second treatment zone and by which treatment medium can be passed from the receiving tank of one treatment zone into the receiving tank of a preceding treatment zone, counter to the conveying direction.

Installations of this kind are used commercially particularly for rinsing vehicle wheels. There and also in the treatment of other articles, fully deionized water is often used as the fresh liquid treatment medium. In installations of this kind, the “cascade rinsing” technique has become established, in which a plurality of treatment zones are arranged in series and the inflow of fresh treatment medium takes place only in the last treatment zone. In practice, the articles are sprayed with the fresh treatment medium in the third treatment zone in order to perform a kind of final rinsing operation. The treatment medium which is passed from the third treatment zone into the receiving tank of the second treatment zone is consequently the fresh treatment medium which is laden with possibly the last contaminants on the vehicle wheels; however, this treatment medium that is passed on can generally be referred to as clean.

There are normally more than three treatment zones in the conveying direction; however, the consideration of three treatment zones, as defined at the outset, is sufficient for the present invention. These three treatment zones which are considered do not have to be traversed directly one after the other in the treatment process, it also being possible for other treatment steps to be inserted if appropriate. In the present case, only the rinsing cascade mentioned is relevant, involving the receiving tanks of the treatment zones considered.

When the articles are conveyed from one treatment zone to the next, some part of the treatment medium always adheres to the surface of the articles; this is referred to as entrainment or carryout. The rinsing effect in the treatment zones declines to an ever greater extent in the conveying direction with increasing entrainment of the treatment medium. Analysis of the concentration of contaminants in the treatment medium as the operation continues is therefore required in order to achieve constant treatment or rinsing results.

It is customary in the case of commercially known installations for the treatment medium in the receiving tank of the second treatment zone in the conveying direction of the three treatment zones considered to be monitored using conductivity measurement, for example. Accordingly, this second treatment zone defines a monitoring zone. Thus, in the prior art, monitoring takes place in the treatment zone which is arranged in such a way ahead of the treatment zone with the supply of fresh treatment medium that the treatment medium from said zone enters the receiving tank of the monitoring zone. In general, this third treatment zone, in which the inflow of fresh treatment medium takes place, is the last treatment zone of the treatment chamber. In this case, therefore, monitoring takes place in the penultimate treatment zone.

The conductivity of the treatment medium reflects the presence of ions in the treatment medium. If appropriate, fresh treatment medium is fed into the treatment medium in the receiving tank of the second treatment zone in a separate step. In known installations of the type stated at the outset, the supply of fresh treatment medium in the third treatment zone, i.e. the volume flow at which fresh treatment medium is fed in there, is constant.

It is then the object of the invention to provide an installation of the type stated at the outset which allows more precise monitoring of the treatment medium and a more flexible response to changes in the treatment medium.

In the case of an installation of the type stated at the outset, this object is achieved by virtue of the fact that
f) the first treatment zone is used to provide a monitoring zone, the receiving tank of which is a control tank and in which the state of the treatment medium in the control tank can be monitored by means of a measuring device.

The invention is based on the insight that a more informative result of measurement can be achieved if monitoring of the state of the treatment medium is carried out in the receiving tank two treatment zones ahead of the treatment zone in which fresh treatment medium flows in. The direct dilution of the treatment medium in the receiving tank immediately ahead of this inflow treatment zone by the fresh treatment medium can have the effect that the treatment medium is in a relatively pure state, although this is not representative of the degree of entrainment of contaminants over the conveying distance.

It is particularly advantageous if the measuring device comprises at least one conductivity sensor and/or at least one concentration sensor, in particular a turbidity sensor. The conductivity and turbidity of the treatment medium are particularly characteristic parameters by means of which the state of the treatment medium in the control tank can be effectively detected. As mentioned, the electrical conductivity of the treatment medium is a parameter for detecting the ions dissolved in the treatment medium. By way of the turbidity, the concentration of inorganic or organic particles in the treatment medium can be detected.

An advantageous measuring device is formed if it comprises a measuring line, through which treatment medium from the control tank can flow for the purpose of measurement. The sensors which are present are then preferably arranged in the measuring line and are thus impinged upon or traversed by the flow of treatment medium.

In a particularly advantageous way, the installation can respond flexibly to the measurement results obtained if there is a control unit, which communicates with the measuring device and controls the supply of fresh treatment medium in the last treatment zone in accordance with the output signals of the measuring device.

For this purpose, the treatment device of the third treatment zone preferably comprises a plurality of discharge devices, by means of which fresh treatment medium can be discharged independently of one another.

It is particularly advantageous here if different volume flows can be discharged by the discharge devices.

Advantageous possibilities of adjusting the volume flows are obtained if there are three discharge devices, by means of which volume flows can be discharged in a ratio of 50:15:35. The discharge devices can be opened or closed by means of simple on-off valves, for example, e.g. simple check valves, without the need for more complex control valves with a variable flow cross section.

An illustrative embodiment of the invention is explained in greater detail below by means of the single FIGURE.

In the FIGURE, an installation for the treatment of articles 12 is denoted overall by 10. As articles 12, the illustrative embodiment under consideration shows vehicle wheels 14 by way of example, these also being referred to in every day terms as vehicle wheel rims. However, it is also possible for articles 12 other than such vehicle wheels 14 to be treated, in particular, for example, parts or attached parts of vehicle bodies, such as individual panel components, bumpers, housings of wing mirrors or the like.

As a treatment chamber 16, the installation 10 comprises a treatment tunnel 18, which is bounded by a housing 20 and of which only a section 18a is shown in the FIGURE. The installation 10 is designed as a through-feed installation and the articles 12 are conveyed through the treatment tunnel 18 continuously with the aid of a conveying system 22. In the illustrative embodiment under consideration, the conveying system 22 is designed as an overhead conveying system 24, which is known per se and is shown only in highly schematized form. This system comprises a circulating drive strand 26, e.g. a circulating drive chain. The mounting thereof and the drive unit which is present are not shown specifically. Coupled to the drive strand 26 is a multiplicity of transfer hangers 28, on each of which one or more articles 12 to be treated can be secured. Small components can also optionally be treated with the installation 10. In this case, the transfer hangers 28 can also carry one or more workpiece baskets, in which such small components can be placed more or less loosely.

In the illustrative embodiment under consideration, the installation 10 is used to clean the vehicle wheels 14 so that they can pass through downstream production processes in a clean state. For example, the vehicle wheels 14 can be provided with a coating after cleaning.

The cleaning process takes place in several stages, in which the vehicle wheels 14 are treated with a liquid treatment medium. For this purpose, the treatment tunnel 18 is divided into a plurality of treatment zones 30, which consequently define rinsing zones here and of which three treatment zones 32, 34 and 36 are shown in the FIGURE. In the illustrative embodiment under consideration, these are the three last treatment zones, which are traversed to complete the cleaning process, of a total of n treatment zones 30 of the installation 10, wherein treatment zone 36 is the last treatment zone 30g.

It is also possible for a plurality of processing sections to be provided in the treatment tunnel 18, each of which comprises such treatment zones 30ₙ₋₂, 30ₙ₋₁ and 30ₙ, which should then each be considered separately.

In treatment zone 36, fresh treatment medium 40, which is fully deionized water in the illustrative embodiment under consideration, is applied to the vehicle wheels 14 by a treatment device 38.

In the FIGURE, the conveying direction in which the articles 12 are conveyed through the treatment tunnel 18 is indicated by an arrow 42. Expressed in general terms, treatment zones 32, 34 and 36 form a first treatment zone 32, a second treatment zone 34 and a third treatment zone 36, which has the treatment chamber 16, in the conveying direction 42. In the illustrative embodiment under consideration, the second treatment zone 34 is consequently the penultimate treatment zone 30ₙ₋₁ and, in the illustrative embodiment under consideration, the first treatment zone 32 is consequently the third-from-last treatment zone 30ₙ₋₂.

In the illustrative embodiment under consideration, the treatment device 38 of the third and, in this case, last treatment zone 36 comprises a plurality of discharge devices following on from one another in the conveying direction 42, by means of which fresh treatment medium 40 can be discharged independently of one another. In the illustrative embodiment under consideration, three discharge devices 44, 46 and 48 are shown by way of example in the conveying direction. The discharge devices 44, 46 and 48 are designed as pairs of nozzle bars 50 of identical construction, wherein the two nozzle bars of a discharge device 44, 46, 48 each flank the conveying path of the vehicle wheels 14 in such a way that the vehicle wheels 14 can be sprayed with fresh treatment medium 40 from both sides. Of each pair of nozzle bars 50, only one nozzle bar in each case is visible in the FIGURE. The nozzle bars 50 have a multiplicity of nozzle openings 52, via which the fresh treatment medium 40 can be applied at high pressure to the vehicle wheels 14 as said wheels are conveyed past the nozzle bars 50.

In a modification (not shown specially), the discharge devices 44, 46 and 48 can also be of structurally different design, being designed as tapered and/or gusher nozzles, for example.

The discharge devices 44, 46, 48 are supplied with treatment medium 40 from a treatment medium source 54. Leading off from the treatment medium source 54 is a supply line 56, which merges into a primary line 58 and a secondary line 60 at a branch point downstream of the source 54. The primary line 58 leads to the first discharge device 44 in the conveying direction 42. For its part, the secondary line 60 merges at another branch point into two line branches 62 and 64, of which the first line branch 62 leads to the second discharge device 46 in the conveying direction 42 and the second line branch 64 leads to the third discharge device 48 in the conveying direction 42.

Respective filters 66 and 68 are arranged in the primary line 58 and in the secondary line 60, through which filters the treatment medium 40 flows in order, as a final conditioning step, to ensure that the treatment medium 40 is not carrying any solid particles when it is sprayed onto the vehicle wheels 14.

The supply of treatment medium 40 to the discharge devices 44, 46, 48 is controlled with the aid of a valve arrangement 70, which comprises two valves 58a and 58b, which are arranged before and after the filter 66 in the primary line 58 in the direction of the discharge devices 44, 46, 48, a valve 60a before the filter 68 in the secondary line 60 and respective valves 62a and 64a in the first line branch 62 and the second line branch 64. The volume flow through the primary line 58 and the secondary line 60 can be detected by means of a flow meter 72.

The discharge devices 44, 46 and 48 are designed in such a way that they can discharge volume flows in a ratio of 50:15:35 in relation to the volume flow in the supply line 56. For this purpose, the ratio of the volume flows through the primary line 58 and the secondary line 60 is 50:50, based on the volume flow in the supply line 56. The ratio of the volume flows through the first line branch 62 and the second line branch 64 is then 30:70, based on the volume flow in the secondary line 60, which is equivalent to volume flows of 15% and 35%, respectively, based on the volume flow in the supply line 56.

In the case of a volume flow of 100% with valves 58a, 60b as well as 58b, 62a and 64a open, volume flows of fresh treatment medium 40 of about 15%, 35%, 50%, 65%, 85% and 100% can be produced in stages. In this case, a volume flow of 50% can optionally be achieved by means of discharge device 44 alone or jointly by means of the two discharge devices 46 and 48.

In a modification (not shown specially), the primary line 58 can branch at a branch point into three secondary lines with technically corresponding valves 58b, 62a and 64a. It is also possible for a filter to be provided only in the supply line 56.

Spray nozzle devices 74 known per se, by means of which the vehicle wheels 14 can be sprayed with treatment medium from both sides along the conveying path, are accommodated in the treatment zones 30, which are arranged ahead of the last treatment zone 36 in the conveying direction 42. Instead of such spray nozzles, it is also possible for there to be other nozzle systems known per se, by means of which the treatment medium can be applied to the articles 12.

In the bottom region of each treatment zone 30, with the exception of the last treatment zone 36, there is in each case a receiving tank 76 associated with the spray nozzle device 74 of the respective treatment zone 30, into which tank the treatment medium flows and drips off the vehicle wheels 14 and consequently carries along the contaminants taken up from the vehicle wheels 14. The treatment medium in the receiving tanks 76 is denoted by 78. The receiving tanks 76 are each connected to an outlet line 80, which merges at an outlet point 82 into a discharge line 84, via which the treatment medium 78 can be carried out of the receiving tank 76 in a circuit to the associated spray nozzle device 74. A pump 86 is arranged in the outlet line 80.

Moreover, a transfer line 88 starts out from the outlet point 82 of the discharge line 84. A valve 90 is arranged upstream of the outlet point 82 in the outlet line 80, and a valve 92 is arranged downstream of the outlet point 82 in the transfer line 88. By means of the transfer lines 88, it is possible to feed further systems situated downstream of valve 92. If appropriate, it is also possible to dispense with the transfer lines 88 and valve 92.

By means of a valve 94 arranged in the discharge line 84, it is possible finally to adjust the discharge volume flow which is to reach the spray nozzle device 74. As a supplementary measure, a pressure measuring device 96, by means of which the line pressure in the discharge line 84 can be monitored, is provided in the discharge line 84.

Each receiving tank 76 comprises an overflow 98, via which treatment medium 78 can be passed out of the receiving tank 76 of one treatment zone 30, counter to the conveying direction 42, into the receiving tank 76 of a preceding treatment zone 30, which is arranged directly ahead of the treatment zone 30 in the conveying direction 42. Owing to the overflows 98, the filling level decreases from receiving tank 76 to receiving tank 76 in a direction counter to the conveying direction 42.

The treatment medium which flows or drips off the vehicle wheels in the last treatment zone 36 is passed into the receiving tank 76 of the penultimate treatment zone 34 via a sloping flow plate 100, which can also be designed as a channel or the like.

In respect of the overflows 98, the basic construction of the installation 10 thus corresponds to the “cascade rinsing” arrangement known per se and discussed at the outset, in which a plurality of rinsing zones containing receiving tanks 76 is arranged in succession, wherein the inflow of fresh treatment medium takes place only in the last treatment zone 36. The receiving tank 76 (not shown here) of the treatment zone 301 which is arranged in the very first position in the conveying direction 42 furthermore comprises a drain opening, via which treatment medium 78 can be drained out of the respective receiving tank 76; only there is waste water produced.

The treatment zone 32, which is the first in the conveying direction 42 and is the third-from-last here, defines a monitoring zone 102, in which the state of the treatment medium in the receiving tank 76 at that point is monitored and checked with the aid of a measuring device 104. Thus the receiving tank 76 in the monitoring zone is a control tank 106.

To detect the dissolved ions, the measuring device 104 comprises a conductivity sensor 108, by means of which the conductivity of the treatment medium 78 in the control tank 108 can be determined. Moreover, the measuring device 104 comprises a concentration sensor, which, in the illustrative embodiment under consideration, is designed as a turbidity sensor 110, by means of which it is possible to determine the turbidity of the treatment medium 78 in the control tank 106 and, by this means, the concentration of inorganic or organic particles.

The measuring device 104 comprises a measuring line 112, through which treatment medium 78 from the control tank 106 flows for the purpose of measurement. This measuring line 112 branches off from the transfer line 88, the outlet point is arranged between the pump 86 in the outlet line 80 and the valves 92, 94 in the transfer line 88 and the discharge line 84, respectively. Thus, treatment medium 78 from the control tank 106 can be conveyed into the measuring line 112 when the valves 92 and 94 in the transfer line 88 and the discharge line 84, respectively, are closed. To enable the measuring line 112 to be closed, a further valve 114 is arranged there at the outlet point.

The conductivity sensor 108 and the turbidity sensor 110 are arranged in or on the measuring line in such a way that the treatment medium 78 flows through them. The measuring line 112 ends with an outlet end 116 at the control tank 106, such that the treatment medium 78 is fed back to the control tank 106 in a circuit after it has flowed through the measuring line 112 and the sensors 108 and 110 located there.

The measuring device 104 communicates with a control unit 118, by means of which the supply of fresh treatment medium 40 in the last treatment zone 36 can be controlled in accordance with the output signals of the measuring device 104. In the illustrative embodiment under consideration, the valves 58b, 62a and 64a are controlled while taking into account the sensor values of the sensors 108 and 110.

The installation 10 operates as follows:

As mentioned above, the vehicle wheels 14 are conveyed through the treatment tunnel 18 in the conveying direction 42 by means of the conveying system 22. In each treatment zone 30, the vehicle wheels 14 are sprayed with the treatment medium 78 from the respective receiving tank 76 by means of the spray nozzle device 74 at that location. When the installation is put into operation, the spray nozzle devices 74 are first of all rinsed exclusively with fresh treatment medium 40 from the source 54 until the volume of treatment medium 78 in the associated receiving tank 76 is such that it can be circulated as described above, for which purpose the valves 90, 92 and 94 are each controlled accordingly.

As explained at the outset, the entrainment of the contaminants from one treatment zone 30 to the next has the effect that the cleaning effect would decline from treatment zone 30 to treatment zone 30 in the conveying direction 42 if further measures were not taken. This effect is counteracted by the overflows 98 between the receiving tanks 76. The treatment medium 78 in the receiving tank 76 of the penultimate treatment zone 34 is diluted to a relatively great extent in respect of the contaminants present therein by the treatment medium which flows in from the last treatment zone 36 via the flow plate 100 since only a very small amount of contaminants adheres to the vehicle wheels 14 which reach the last treatment zone 36. As a result, the treatment medium 78 in the receiving tank 76 of the penultimate treatment zone 34 can achieve a greater cleaning effect.

The treatment medium 78 diluted in this way passes via the overflow 98 of the penultimate treatment zone 34 into the receiving tank 76 of the third-from-last treatment zone 32, where it dilutes the treatment medium 78 there, which passes to the preceding treatment zone 30 in the conveying direction 42 via the overflow 98 there, etc.

In this way, it is consequently the treatment medium 78 with the greatest degree of entrainment, i.e. the treatment medium 78 in the receiving tank 76 of the penultimate treatment zone 34, which is diluted to the greatest extent by the largely uncontaminated treatment medium from the last treatment zone 36, and the dilution effect decreases from receiving tank 76 to receiving tank 76 counter to the conveying direction 42. Since the degree of contamination due to the cleaning itself and due to the entrainment is greater in the previous receiving tanks 76, a kind of equilibrium is established, with the result that the treatment medium 78 in the receiving tanks 76 can be in the same state on average.

The quantity of fresh treatment medium 40 which is discharged onto the vehicle wheels 14 by the treatment device 38 in the last treatment zone 36 and is used for this successive dilution is then adjusted by means of the control unit 118, in accordance with the results of the measuring device 104 of the first treatment zone 32 or 30ₙ₋₂—in the conveying direction 42—of the three treatment zones 32, 34, 36 considered here, by controlling the valves 58b, 60a as well as 62a and 64a accordingly.

By means of the primary line 58, the secondary line 60 and the line branches 62, 64, it is now possible selectively to define how much fresh treatment medium 40 is discharged onto the vehicle wheels 14, as explained above. In this way, a kind of fine adjustment of the supply of fresh treatment medium 40 is possible.

What is claimed is:

1. An installation for the treatment of articles with a liquid treatment medium, comprising:
a) a treatment chamber, through which articles can be conveyed in a conveying direction by means of a conveying system, the treatment chamber having at least three treatment zones in the conveying direction in which treatment medium can be applied to the articles;
wherein
b) a third treatment zone in the conveying direction comprises a treatment device, to which fresh liquid treatment medium can be supplied;
c) a second treatment zone in the conveying direction and a first treatment zone in the conveying direction each comprise a receiving tank for liquid treatment medium which drips off or flows off the articles;
d) in the second treatment zone and in the first treatment zone, the liquid treatment medium from the respective receiving tank can be applied to the articles;
e) means by which treatment medium can be passed from the third treatment zone into the receiving tank of the second treatment zone and by which liquid treatment medium can be passed from the receiving tank of one treatment zone into the receiving tank of a preceding treatment zone, counter to the conveying direction,
wherein
f) the first treatment zone is used to provide a monitoring zone, the receiving tank of the first treatment zone being a control tank and in which the state of the liquid treatment medium in the control tank can be monitored by a measuring device.

2. The installation as claimed in claim 1, wherein the measuring device comprises at least one conductivity sensor and/or at least one concentration sensor.

3. The installation as claimed in claim 1, wherein the measuring device comprises a measuring line, through which liquid treatment medium from the control tank can flow for the purpose of measurement.

4. The installation as claimed in claim 1, further comprising there is a control unit which communicates with the measuring device and controls the supply of fresh liquid treatment medium in the third treatment zone in accordance with the output signals of the measuring device.

5. The installation as claimed in claim 1, wherein the treatment device of the third treatment zone comprises a plurality of discharge devices, by means of which fresh liquid treatment medium can be discharged independently of one another.

6. The installation as claimed in claim 5, wherein different volume flows can be discharged by each discharge device from the plurality of discharge devices.

7. The installation as claimed in claim 6, wherein the plurality of discharge devices comprises three discharge devices, by means of which volume flows can be discharged in a ratio of 50:15:35.

8. The installation as claimed in claim 1, wherein the measuring device comprises at least one conductivity sensor and/or at least one turbidity sensor.
